(19) United States
(12) Patent Application Publication
(10) Pub. No.: US 2025/0011587 A1
(43) Pub. Date: Jan. 9, 2025

(54) INJECTION MOLDING METHOD, RESIN COMPOSITION FOR MOLDING, AND MOLDED BODY

(71) Applicant: KABUSHIKI KAISHA TOKAI-RIKA-DENKI-SEISAKUSHO, Niwa-gun, Aichi-ken (JP)

(72) Inventors: Kenichiro NAKANE, Aichi (JP); Takayasu MUTO, Aichi (JP); Toshiki HARA, Aichi (JP); Sotaro YOSHIHARA, Aichi (JP); Daiki KOJIMA, Aichi (JP); Tetsuo TAKAYAMA, Yamagata (JP)

(21) Appl. No.: 18/699,974

(22) PCT Filed: Sep. 26, 2022
(86) PCT No.: PCT/JP2022/035785

§ 371 Date: Apr. 10, 2024

(30) Foreign Application Priority Data
Oct. 21, 2021 (JP) 2021-172695

(51) Int. Cl. C08L 9/06; B29C 45/00; B29C 45/16; B29K 23/00; B29K 55/02; B29K 105/00

(52) U.S. Cl. CPC C08L 9/06; B29C 45/0001; B29C 45/164; B29C 2045/1664; B29K 2023/12; B29K 2055/02; B29K 2105/0005; B29K 2105/0094

(57) ABSTRACT

An injection molding method, including injecting a resin composition for molding as a raw material, the resin composition including at least two resins having different apparent viscosities at 230° C. and at least one compatibilizer.

### TECHNICAL FIELD

The present disclosure relates to an injection molding method, a resin composition for molding, and a molded body.

### BACKGROUND ART

Injection molding is one of molding methods using a mold. By heating and melting a material such as a resin, feeding into a mold, and cooling, the material can be shaped into a desired shape. Injection molding is used in a wide range of fields because it allows articles of desired shapes to be manufactured continuously and quickly in large quantities.

For example, Japanese Patent Application Laid-Open (JP-A) No. 2016-199654 A discloses a molded body with excellent impact-resistance obtained by injection molding a resin composition containing a styrene-based resin, polylactic acid, and a copolymer of butadiene and an ethylenically unsaturated carboxylic acid ester.

### SUMMARY OF INVENTION

### Technical Problem

However, conventionally, production of a molded body using different resins that form a core portion and a shell portion that covers the core portion cannot be done by just one injection molding, but requires multiple steps such as two-color molding or painting. Even in JP-A No. 2016-199654, there is no viewpoint of producing a molded body that has a structure having a core portion and a shell portion.

The present disclosure has been made in view of the above, and an object of the present disclosure is to provide an injection molding method that allows a molded body having a structure in which a core portion and a shell portion are formed of different resins to be obtained by one injection molding of a resin composition, a resin composition for molding used in the method, and a molded body obtained by the method.

### Solution to Problem

Specific means to solve the above problems include the following aspects.

<1> An injection molding method, including injecting a resin composition for molding as a raw material, the resin composition including at least two resins having different apparent viscosities at 230° C. and at least one compatibilizer.

<2> The injection molding method according to <1>, in which the resins include a resin A and a resin B, a difference in apparent viscosity between the two resins with a smallest difference in apparent viscosity at 230° C. among the at least two resins being from 1000 Pa·s to 50000 Pa·s.

<3> The injection molding method according to <2>, in which a ratio (η_{B}/η_{A}) of an apparent viscosity (η_{B}) of the resin B at 230° C. to an apparent viscosity (η_{A}) of the resin A at 230° C. is from 0.01 to 0.4.

<4> The injection molding method according to <2> or <3>, in which the compatibilizer includes a first compatibilizer that is compatible with the resin A and a second compatibilizer that is compatible with the resin B.

<5> The injection molding method according to <4>, in which the resin A is from 40% by mass to 99% by mass, the resin B is from 0.1% by mass to 40% by mass, the first compatibilizer is from 0.1% by mass to 20% by mass, and the second compatibilizer is from 0.1% by mass to 20% by mass, each with respect to a total mass of the resin composition for molding.

<6> The injection molding method according to <4> or <5>, in which the first compatibilizer and the second compatibilizer are both organic compounds.

<7> The injection molding method according to any one of <4> to <6>, in which the resin A is a resin containing a constitutional unit derived from an aromatic hydrocarbon, and the resin B is a resin containing a constitutional unit derived from an unsaturated aliphatic hydrocarbon.

<8> The injection molding method according to <7>, in which:
the first compatibilizer and the second compatibilizer are copolymers;
a content of the constitutional unit derived from an aromatic hydrocarbon in the first compatibilizer exceeds 50% by mass with respect to all constitutional units of the first compatibilizer; and
a content of the constitutional unit derived from an unsaturated aliphatic hydrocarbon in the second compatibilizer exceeds 50% by mass with respect to all constitutional units of the second compatibilizer.

<9> A resin composition for molding, including at least two resins and at least one compatibilizer, in which the resins include a resin A and a resin B, a difference in apparent viscosity between the two resins with a smallest difference in apparent viscosity at 230° C. among the at least two resins being from 1000 Pa·s to 50000 Pa·s.

<10> The resin composition for molding according to <9>, in which a ratio (η_{B}/η_{A}) of an apparent viscosity (η_{B}) of the resin B at 230° C. to an apparent viscosity (η_{A}) of the resin A at 230° C. is from 0.01 to 0.4.

<11> The resin composition for molding according to <9> or <10>, in which the compatibilizer includes a first compatibilizer that is compatible with the resin A and a second compatibilizer that is compatible with the resin B.

<12> The resin composition for molding according to <11>, in which the first compatibilizer and the second compatibilizer are both organic compounds.

<13> The resin composition for molding according to <11> or <12>, in which the resin A is a resin containing a constitutional unit derived from an aromatic hydrocarbon, and the resin B is a resin containing a constitutional unit derived from an unsaturated aliphatic hydrocarbon.

<14> The resin composition for molding according to <13>, in which:
the first compatibilizer and the second compatibilizer are copolymers;
a content of the constitutional unit derived from an aromatic hydrocarbon in the first compatibilizer exceeds 50% by mass with respect to all constitutional units of the first compatibilizer; and
a content of the constitutional unit derived from an unsaturated aliphatic hydrocarbon in the second compatibilizer exceeds 50% by mass with respect to all constitutional units of the second compatibilizer.

<15> A molded body, including:
a core portion that includes a cured product of a resin A;
a shell portion that includes a cured product of a resin B and that covers at least a part of the core portion; and
an intermediate portion that is located between the core portion and the shell portion and that includes a cured product of at least one compatibilizer,
in which concentrations of the resin A and the resin B each have a distribution that continuously changes from the core portion toward the shell portion.

<16> The molded body according to <15>, in which the compatibilizer includes at least two compatibilizers.

<17> The molded body according to <15> or <16>, in which the shell portion has a thickness of 300 μm or less.

### Advantageous Effects of Invention

According to the present disclosure, an injection molding method that allows a molded body having a structure in which a core portion and a shell portion are formed of different resins to be obtained by one injection molding of a resin composition, a resin composition for molding used in the method, and a molded body obtained by the method are provided.

### BRIEF DESCRIPTION OF DRAWINGS

FIG. 1 is a schematic diagram showing a flow of a molten resin composition for molding when the resin composition for molding is injection molded.

FIG. 2 is a schematic diagram showing a cross section of a molded body.

FIG. 3 is an enlarged view of the cross section of the molded body.

FIG. 4 represents micrographs showing cross sections of molded bodies before and after acetone vapor etching.

FIG. 5 represents micrographs showing cross sections of molded bodies before and after acetone vapor etching.

FIG. 6 is a micrograph showing a structure of a molded body.

### DESCRIPTION OF EMBODIMENTS

Hereinafter, one embodiment of the present disclosure will be described in detail. However, the present disclosure is not limited to the following embodiments. In the following disclosure, constituent elements (including elemental steps, etc.) are not essential unless otherwise specified. The same applies to numerical values and their ranges, which do not limit the present disclosure.

In the present disclosure, the term “step” includes not only a step that is independent from other steps, but also a step that cannot be clearly distinguished from other steps as long as the purpose of the step is achieved.

In the present disclosure, numerical ranges indicated using “to” include the numerical values described before and after “to” as lower and upper limits, respectively.

In the numerical ranges described stepwise in the present disclosure, the upper limit or lower limit described in one numerical range may be replaced with the upper limit or lower limit of another numerical range described stepwise. Further, in the numerical ranges described in the text, the upper limit or lower limit of the numerical range may be replaced with the value shown in the Examples.

In the present disclosure, if there are multiple types of substances corresponding to each component in the composition, the content of each component in the composition means a total content of the multiple types of substances present in the composition, unless otherwise specified.

### <<Injection Molding Method>>

The injection molding method of the present disclosure includes injecting a resin composition for molding as a raw material, the resin composition including at least two resins having different apparent viscosities at 230° C. and at least one compatibilizer.

When the resin composition for molding as a raw material, the resin composition including at least two resins having different apparent viscosities at 230° C. and at least one compatibilizer is injected, a molded body having a structure in which a core portion and a shell portion are formed of different resins is obtained by one injection molding of the resin composition

The effect of the injection molding method of the present disclosure is not clear, but it is presumed as follows.

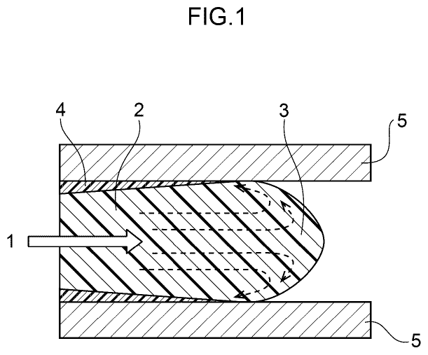

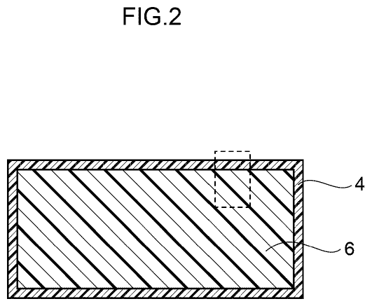

FIG. 1 shows a schematic diagram when a resin composition for molding including at least two resins having different apparent viscosities at 230° C. is melted and injection molded. The molten resin composition for molding flows within the mold 5 in the direction 1 along which the molten resin composition for molding flows. At this time, based on the principle of fountain flow, the molten low-viscosity resin 3 flows within the mold 5 more rapidly than the molten high-viscosity resin 2, and rapidly moves toward the surface side of the mold 5 along the flow shown by the dotted line arrow in FIG. 1. On the other hand, the molten high-viscosity resin 2 flows within the mold 5 more slowly than the molten low-viscosity resin 3, so it is difficult to move toward the surface side of the mold and remains in the center of the mold. Then, these resins are naturally cooled and solidified by the mold, and a molded body having a structure having a core portion and a shell portion as shown in FIG. 2 is formed. At this time, when the high-viscosity resin 2 has a higher viscosity and the difference in apparent viscosity between the high-viscosity resin 2 and the low-viscosity resin 3 is larger, a molded body having a structure having a core portion and a shell portion is formed more easily.

Furthermore, since the resin composition for molding in the present disclosure includes at least one compatibilizer, the compatibilizer is present between the at least two resins, by which the resins can adhere to each other to form a single formed body without causing phase separation.

That is, according to the injection molding method of the present disclosure, a molded body having a structure in which a core portion and a shell portion are formed of different resins can be obtained by one injection molding of the resin composition.

Note that the present disclosure is not limited to the above estimated mechanism.

### <Resin Composition for Molding>

### (Resin)

In the injection molding method of the present disclosure, the at least two resins having different apparent viscosities at 230° C. preferably include a resin A and a resin B, a difference in apparent viscosity between the two resins with a smallest difference in apparent viscosity at 230° C. among the at least two resins being from 1000 Pa·s to 50000 Pa·s, more preferably include a resin A and a resin B, a difference in apparent viscosity between the two resins with a smallest difference in apparent viscosity at 230° C. among the at least two resins being from 3000 Pa·s to 50000 Pa·s, and even more preferably include a resin A and a resin B, a difference in apparent viscosity between the two resins with a smallest difference in apparent viscosity at 230° C. among the at least two resins being from 5000 Pa·s to 50000 Pa s, from the viewpoint that a molded body having a structure in which a core portion and a shell portion are formed of different resins can be easily obtained by one injection molding of the resin composition. When the aforementioned “two resins with a smallest difference in apparent viscosity at 230° C. among the at least two resins” have the difference in apparent viscosity as described above, they can each constitute a core portion or a shell portion in a molded body.

In the injection molding method of the present disclosure, for example, when two resins having different apparent viscosities at 230° C. are used, the “difference in apparent viscosity at 230° C.” is a difference in apparent viscosity between the two resins, the preferred difference in apparent viscosity is the same as above, and the two resins can each constitute a core portion or a shell portion in a molded body.

In the injection molding method of the present disclosure, the “at least two resins having different apparent viscosities at 230° C.” do not include the “compatibilizer” described below.

In the injection molding method of the present disclosure, the at least two resins having different apparent viscosities at 230° C. preferably has a ratio (η_{B}/η_{A}), of an apparent viscosity (η_{B}) of the resin B at 230° C. to an apparent viscosity (η_{A}) of the resin A at 230° C. in the resin A and the resin B with a smallest difference in apparent viscosity at 230° C. among the at least two resins, of from 0.01 to 0.4, more preferably from 0.01 to 0.3, and even more preferably from 0.01 to 0.2, from the viewpoint that a molded body having a structure in which a core portion and a shell portion are formed of different resins can be easily obtained by one injection molding of the resin composition. When the aforementioned “resin A and resin B with a smallest difference in apparent viscosity at 230° C. among the at least two resins” have the ratio of apparent viscosities as described above, they can each constitute a core portion or a shell portion in a molded body.

In the injection molding method of the present disclosure, for example, when two resins having different apparent viscosities at 230° C. are used, the “ratio (η_{B}/η_{A})” is a ratio (η_{B}/η_{A}) of the two resins, the preferred ratio (η_{B}/η_{A}) is the same as above, and the two resins can each constitute a core portion or a shell portion in a molded body.

In the present disclosure, the measurement of the apparent viscosity of the resin at 230° C. is as follows. Specifically, a melt volume rate (MVR) is measured based on Annex C of JIS K7210. Then, according to the method of expressing the results in Annex JA. 8 (Formula No. JA.4) of JIS K7210, a flow value Q (cm³/s) is calculated using the MVR value, and an apparent viscosity (Pa·s) is calculated.

The type of the resin is not particularly limited, and may be a homopolymer or a copolymer. When the resin is a copolymer, the resin may be a random copolymer, a block copolymer, or a graft copolymer. The resin is preferably a thermoplastic resin, and may be a thermoplastic elastomer (TPE). Examples of the resin include acrylonitrile-butadiene-styrene copolymer (ABS resin), polystyrene resin (PS resin), polyamide resin (PA resin, such as nylon 6T, nylon 6I, or nylon 9T), polybutylene terephthalate resin (PBT resin), polyethylene terephthalate resin (PET resin), polycarbonate resin (PC resin), polyphenylene sulfide resin (PPS resin), polyphenylene ether resin (PPE resin), polyimide resin (P1 resin), polyether ether ketone resin (PEEK resin), liquid crystal polymer resin (LCP resin), high impact polystyrene (HIPS resin), styrene butadiene rubber (SBR resin), acrylonitrile-ethylene propylene rubber-styrene copolymer (AES resin), acrylonitrile-acrylic rubber-styrene copolymer polymer (AAS resin), methyl methacrylate-butadiene rubber-styrene copolymer (MBS resin), acrylonitrile-styrene copolymer (AS resin), methyl methacrylate-styrene copolymer (MS resin), polypropylene resin (PP resin), polyethylene resin (PE resin), polymethyl methacrylate resin (PMMA resin), acrylonitrile-butadiene-styrene copolymer (ABS resin), and polyoxymethylene resin (POM resin).

In the injection molding method of the present disclosure, the types of the at least two resins having different apparent viscosities at 230° C. are not particularly limited, but when a resin A and a resin B, with a difference in apparent viscosity between the two resins at 230° C. being the smallest among the at least two resins, are used, the resin A is preferably a resin containing a constitutional unit derived from an aromatic hydrocarbon, and the resin B is preferably a resin containing a constitutional unit derived from an unsaturated aliphatic hydrocarbon.

### —Resin A—

In the resin A in the present disclosure, the type of the constitutional unit derived from an aromatic hydrocarbon is not particularly limited, but examples thereof include a constitutional unit derived from styrene, α-methylstyrene, (o-, m-, p-)methylstyrene, 1,3-dimethyl styrene, vinylnaphthalene, vinylanthracene, (o-, m-, p-)phthalic acid, bisphenol A, dihalogenated benzene, xylenol, pyromellitic anhydride, hydroquinone, 4,4′-difluorobenzophenone, ethylene terephthalate, p-hydroxybenzoic acid, and 6-hydroxy-2-naphthoic acid.

The resin A in the present disclosure may be a homopolymer or a copolymer. When the resin A is a copolymer, the resin A may be a random copolymer, a block copolymer, or a graft copolymer.

The resin A in the present disclosure is preferably a thermoplastic resin, and may be a thermoplastic elastomer (TPE). Examples of the resin A include acrylonitrile-butadiene-styrene copolymer (ABS resin), polystyrene resin (PS resin), polyamide resin (PA resin, such as nylon 6T, nylon 6I, or nylon 9T), polybutylene terephthalate resin (PBT resin), polyethylene terephthalate resin (PET resin), polycarbonate resin (PC resin), polyphenylene sulfide resin (PPS resin), polyphenylene ether resin (PPE resin), polyimide resin (PI resin), polyether ether ketone resin (PEEK resin), liquid crystal polymer resin (LCP resin), high impact polystyrene (HIPS resin), styrene butadiene rubber (SBR resin), acrylonitrile-ethylene propylene rubber-styrene copolymer (AES resin), acrylonitrile-acrylic rubber-styrene copolymer (AAS resin), methyl methacrylate-butadiene rubber-styrene copolymer (MBS resin), acrylonitrile-styrene copolymer (AS resin), and methyl methacrylate-styrene copolymer (MS resin).

The apparent viscosity of the resin A in the present disclosure at 230° C. is preferably from 2000 Pa·s to 100000 Pa·s, more preferably from 5000 Pa·s to 70000 Pa·s, and even more preferably from 10000 Pa·s to 50000 Pa·s, from the viewpoint that a molded body having a structure in which a core portion and a shell portion are formed of different resins can be easily obtained by one injection molding of the resin composition. In the present disclosure, the apparent viscosity at 230° C. is a value calculated according to Annex C of JIS K7210 and the method of expressing the results in Annex JA. 8 (Formula No. JA.4) of JIS K7210 as described above.

The melt flow rate (MFR) of the resin A in the present disclosure is not particularly limited, but it is preferably from 0.01 g/10 min to 20 g/10 min and more preferably from 0.01 g/10 min to 10 g/10 min from the viewpoint that a molded body having a structure in which a core portion and a shell portion are formed of different resins can be easily obtained by one injection molding of the resin composition. In the present disclosure, the melt flow rate (MFR) is a value measured under the conditions of 230° C. and a load of 21.18N in accordance with JIS K7210:1999.

The tensile strength of the resin A in the present disclosure is not particularly limited, but it is preferably from 20 MPa to 300 MPa and more preferably from 30 MPa to 300 MPa from the viewpoint that a molded body having a structure in which a core portion and a shell portion are formed of different resins can be easily obtained by one injection molding of the resin composition. In the present disclosure, the tensile strength is a value measured in accordance with ISO 527.

The deflection temperature under load of the resin A in the present disclosure is not particularly limited, but it is preferably from 80° C. to 150° C. and more preferably from 90° C. to 120° C. at a bending stress of 1.8 MPa from the viewpoint that a molded body having a structure in which a core portion and a shell portion are formed of different resins can be easily obtained by one injection molding of the resin composition. In the present disclosure, the deflection temperature under load is a value measured by flatwise method at a bending stress of 1.8 MPa in accordance with JIS K7191-1.

### —Resin B—

In the resin B in the present disclosure, the type of the constitutional unit derived from an unsaturated aliphatic hydrocarbon is not particularly limited, but examples thereof include a constitutional unit derived from propylene, ethylene, methyl acrylate, methyl methacrylate, and butadiene.

The resin B in the present disclosure may be a homopolymer or a copolymer. When the resin B is a copolymer, the resin B may be a random copolymer, a block copolymer, or a graft copolymer.

The resin B in the present disclosure is preferably a thermoplastic resin, and may be a thermoplastic elastomer (TPE). Examples of the resin B include polypropylene resin (PP resin), polyethylene resin (PE resin), polymethyl methacrylate resin (PMMA resin), and acrylonitrile-butadiene-styrene copolymer (ABS resin).

The apparent viscosity of the resin B in the present disclosure at 230° C. is preferably from 100 Pa·s to 50000 Pa·s and more preferably from 100 Pa·s to 10000 Pa·s from the viewpoint that a molded body having a structure in which a core portion and a shell portion are formed of different resins can be easily obtained by one injection molding of the resin composition. In the present disclosure, the apparent viscosity at 230° C. is a value calculated according to Annex C of JIS K7210 and the method of expressing the results in Annex JA. 8 (Formula No. JA.4) of JIS K7210 as described above.

The melt flow rate (MFR) of the resin B in the present disclosure is not particularly limited, but it is preferably from 0.1 g/10 min to 50 g/10 min and more preferably from 0.5 g/10 min to 50 g/10 min from the viewpoint that a molded body having a structure in which a core portion and a shell portion are formed of different resins can be easily obtained by one injection molding of the resin composition. In the present disclosure, the melt flow rate (MFR) is a value measured under the conditions of 230° C. and a load of 21.18N in accordance with JIS K7210:1999 as described above.

The tensile strength of the resin B in the present disclosure is not particularly limited, but it is preferably from 1 MPa to 300 MPa and more preferably from 10 MPa to 300 MPa from the viewpoint that a molded body having a structure in which a core portion and a shell portion are formed of different resins can be easily obtained by one injection molding of the resin composition. In the present disclosure, the tensile strength is a value measured in accordance with ISO 527 as described above.

### (Compatibilizer)

The compatibilizer in the resin composition for molding used in the injection molding method of the present disclosure preferably include a first compatibilizer that is compatible with the resin A and a second compatibilizer that is compatible with the resin B. By the resin composition for molding used in the injection molding method of the present disclosure including a first compatibilizer that is compatible with the resin A and a second compatibilizer that is compatible with the resin B, a molded body formed by the injection molding method has a structure that continuously contains, from the surface side of the molded body toward the inner side of the molded body, a part mainly containing the resin B, a part mainly containing the resin B and the second compatibilizer, a part mainly containing the second compatibilizer and the first compatibilizer, a part mainly containing the first compatibilizer and the resin A, and a part mainly containing the resin A. At this time, the part mainly containing the resin B to the part mainly containing the resin B and the second compatibilizer is referred to as a “shell portion”, the part mainly containing the second compatibilizer and the first compatibilizer is referred to as an “intermediate portion”, and the part mainly containing the first compatibilizer and the resin A to the part mainly containing the resin A is referred to as a “core portion”. That is, a molded body having a structure in which a core portion and a shell portion are formed of different resins is obtained by one injection molding of the resin composition. Note that the concentrations of the resin A, the resin B, the first compatibilizer, and the second compatibilizer are all continuously distributed in the molded body, so they are each expressed as a “portion” (or “part”) like a shell portion, an intermediate portion, or a core portion, but there is no interface between the portions (parts). Note that a “part mainly containing component X” means that the part contains more than 50% by mass of component X.

Note that, for example, when the resin composition for molding includes the resin A, the resin B. and the first compatibilizer, but does not include the second compatibilizer, a molded body formed by the injection molding method has a structure that continuously contains, from the surface side of the molded body toward the inner side of the molded body, a part mainly containing the resin B, a part mainly containing the resin B and the first compatibilizer, a part mainly containing the first compatibilizer, a part mainly containing the first compatibilizer and the resin A, and a part mainly containing the resin A. At this time, the part mainly containing the resin B to the part mainly containing the resin B and the first compatibilizer is referred to as a “shell portion”, the part mainly containing the first compatibilizer is referred to as an “intermediate part”, and the part mainly containing the first compatibilizer and the resin A to the part mainly containing the resin A is referred to as a “core portion”. That is, a molded body having a structure in which a core portion and a shell portion are formed of different resins is obtained by one injection molding of the resin composition. Note that the concentrations of the resin A, the resin B, and the first compatibilizer are all continuously distributed in the molded body, so they are each expressed as a “portion” (or “part”) like a shell portion, an intermediate portion, or a core portion, but there is no interface between the portions (parts).

Note that when the resin composition for molding includes, for example, three or more resins having different apparent viscosities at 230° C., it is preferable to include four or more compatibilizers. When the resin composition for molding includes, for example, four or more resins having different apparent viscosities at 230° C., it is preferable to include six or more compatibilizers. That is, it is preferable to design the number of types of resin and the number of types of compatibilizer, so that the compatibilizer is present between the cured products of the resins in the molded body obtained by injection molding the resin composition for molding.

The type of the compatibilizer in the present disclosure is not particularly limited, but it is preferable that the compatibilizers in present disclosure are each organic compounds. For example, the first compatibilizer and the second compatibilizer in the present disclosure are preferably both organic compounds.

In the injection molding method of the present disclosure, it is preferable that the first compatibilizer and the second compatibilizer are copolymers, the content of the constitutional unit derived from an aromatic hydrocarbon in the first compatibilizer exceeds 50% by mass with respect to all constitutional units of the first compatibilizer, and the content of the constitutional unit derived from an unsaturated aliphatic hydrocarbon in the second compatibilizer exceeds 50% by mass with respect to all constitutional units of the second compatibilizer. It is more preferable that the content of the constitutional unit derived from an aromatic hydrocarbon in the first compatibilizer exceeds 60% by mass with respect to all constitutional units of the first compatibilizer and the content of the constitutional unit derived from an unsaturated aliphatic hydrocarbon in the second compatibilizer exceeds 60% by mass with respect to all constitutional units of the second compatibilizer, from the viewpoint that a molded body having a structure in which a core portion and a shell portion are formed of different resins can be easily obtained by one injection molding of the resin composition.

The explanation regarding the type of the constitutional unit derived from an aromatic hydrocarbon in the first compatibilizer is the same as the explanation regarding the type of the constitutional unit derived from an aromatic hydrocarbon in the resin A in the present disclosure. The explanation regarding the constitutional unit derived from an unsaturated aliphatic hydrocarbon in the second compatibilizer is the same as the explanation regarding the type of the constitutional unit derived from an unsaturated aliphatic hydrocarbon in the resin B in the present disclosure.

By the first compatibilizer including a constitutional unit derived from an aromatic hydrocarbon and the resin A in the present disclosure including a constitutional unit derived from an aromatic hydrocarbon, the first compatibilizer and the resin A become easily compatible with each other. Furthermore, when the content of the constitutional unit derived from an aromatic hydrocarbon in the first compatibilizer is high with respect to the total constitutional units of the first compatibilizer, the first compatibilizer and the resin A become more easily compatible with each other. Similarly, by the second compatibilizer including a constitutional unit derived from an unsaturated aliphatic hydrocarbon and the resin B in the present disclosure including a constitutional unit derived from an unsaturated aliphatic hydrocarbon, the second compatibilizer and the resin B become easily compatible with each other. Furthermore, when the content of the constitutional unit derived from an unsaturated aliphatic hydrocarbon in the second compatibilizer is high with respect to the total constitutional units of the second compatibilizer, the second compatibilizer and the resin B become more easily compatible with each other.

As the compatibilizer, a reactive compatibilizer or a non-reactive compatibilizer can be used. The reactive compatibilizer is a polymer compound having a reactive group. Examples of the reactive group include a maleic anhydride group, a carboxylic acid group, an epoxy (glycidyl) group, and an oxazoline group. Moreover, compatibility can be adjusted by using a random copolymer, a block copolymer, or a graft copolymer as the non-reactive compatibilizer. Examples of the non-reactive compatibilizer include a styrene-ethylene-styrene copolymer, a styrene-ethylene-butlene-styrene copolymer, and a modified product thereof. More specifically, examples of the compatibilizer include hydrogenated styrene thermoplastic elastomer (SEBS). Examples of the hydrogenated styrene thermoplastic elastomer (SEBS) include a polymer obtained by hydrogenating the double bond portion of a block copolymer consisting of styrene and butadiene.

### (Ratio)

In the resin composition for molding used in the injection molding method of the present disclosure, it is preferable that the resin A is from 40% by mass to 99% by mass, the resin B is from 0.1% by mass to 40% by mass, the first compatibilizer is from 0.1% by mass to 20% by mass, and the second compatibilizer is from 0.1% by mass to 20% by mass, each with respect to the total mass of the resin composition for molding. It is more preferable that the resin A is from 60% by mass to 98% by mass, the resin B is from 1% by mass to 30% by mass, the first compatibilizer is from 0.3% by mass to 10% by mass, and the second compatibilizer is from 0.3% by mass to 10% by mass, each with respect to the total mass of the resin composition for molding, from the viewpoint that a molded body having a structure in which a core portion and a shell portion are formed of different resins can be easily obtained by one injection molding of the resin composition.

### (Other Components)

The resin composition for molding used in the injection molding method of the present disclosure may include other components without going beyond the gist of the present disclosure. For example, other components may be mixed with the resin A or may be mixed with the resin B in advance. For example, by mixing the resin B and other components in advance, then preparing a resin composition for molding, and injection molding the resin composition for molding, it is possible to produce a molded body in which concentrations of the components in the shell portion are high, and concentrations of the components in the core portion are low.

### <Method of Injection Molding>

The method of injection molding of the present disclosure is not particularly limited. The runner used for injection molding may be a cold runner type or a hot runner type. The gate used for injection molding may be a single point gate or multiple gates.

The detailed conditions for injection molding are not particularly limited, but, for example, conditions such as molding temperature, nozzle temperature, mold temperature, weighing value, weighing speed, injection speed (I.S), injection speed (V-P), filling and holding pressure, filling and holding pressure time, cooling time, and injection peak pressure can be appropriately set by those skilled in the art.

### <<Resin Composition for Molding>>

The resin composition for molding of the present disclosure includes at least two resins and at least one compatibilizer, in which the resins include a resin A and a resin B, a difference in apparent viscosity between the two resins with a smallest difference in apparent viscosity at 230° C. among the at least two resins being from 1000 Pa·s to 50000 Pa·s.

As described above, due to the difference in apparent viscosity between the resin A and the resin B, a molded body having a core portion and a shell portion is formed based on the principle of fountain flow. Furthermore, by including at least one compatibilizer, the compatibilizer is present between the at least two resins, by which the at least two resins can adhere to each other to form a single formed body without causing phase separation.

That is, according to the resin composition for molding of the present disclosure, a molded body having a structure in which a core portion and a shell portion are formed of different resins can be obtained by one injection molding of the resin composition.

### (Resin)

In the resin composition for molding of the present disclosure, the difference in apparent viscosity at 230° C. of the resin A and the resin B is preferably from 1000 Pa·s to 50000 Pa·s, more preferably from 3000 Pa·s to 50000 Pa·s, and even more preferably from 5000 Pa·s to 50000 Pa·s, from the viewpoint that a molded body having a structure in which a core portion and a shell portion are formed of different resins can be easily obtained by one injection molding of the resin composition. In the resin composition for molding of the present disclosure, for example, when two resins having different apparent viscosities at 230° C. are used, the “difference in apparent viscosity at 230° C.” is a difference in apparent viscosity between the two resins, and the preferred difference in apparent viscosity is the same as above.

Note that in the resin composition for molding of the present disclosure, the “at least two resins” do not include the “compatibilizer” described below.

In the resin composition for molding of the present disclosure, a ratio (η_{B}/η_{A}) of an apparent viscosity (η_{B}) of the resin B at 230° C. to an apparent viscosity (η_{A}) of the resin A at 230° C. is preferably from 0.01 to 0.4, more preferably from 0.01 to 0.3, and even more preferably from 0.01 to 0.2, from the viewpoint that a molded body having a structure in which a core portion and a shell portion are formed of different resins can be easily obtained by one injection molding of the resin composition. In the resin composition for molding of the present disclosure, for example, when two resins having different apparent viscosities at 230° C. are used, the “ratio (η_{B}/η_{A})” is a ratio (η_{B}/η_{A}) of the two resins, and the preferred ratio (η_{B}/η_{A}) is the same as above.

In the present disclosure, the measurement of the apparent viscosity of the resin at 230° C. is calculated based on Annex C of JIS K7210 and the method of expressing the results in Annex JA. 8 (Formula No. JA.4) of JIS K7210 as described above.

The type of the resin is not particularly limited, and the explanation of the resin in the resin composition for molding of the present disclosure is the same as the explanation of the resin in the injection molding method of the present disclosure, including definitions, examples, preferred embodiments, etc.

The types of the resin A and the resin B in the resin composition for molding of the present disclosure are not particularly limited, but it is preferable that the resin A is a resin containing a constitutional unit derived from an aromatic hydrocarbon and the resin B is a resin containing a constitutional unit derived from an unsaturated aliphatic hydrocarbon.

### —Resin A—

The explanation of the resin A in the resin composition for molding of the present disclosure is the same as the explanation of the resin A in the injection molding method of the present disclosure, including definitions, examples, preferred embodiments, etc.

### —Resin B—

The explanation of the resin B in the resin composition for molding of the present disclosure is the same as the explanation of the resin B in the injection molding method of the present disclosure, including definitions, examples, preferred embodiments, etc.

### (Compatibilizer)

The explanation of the compatibilizer in the resin composition for molding of the present disclosure is the same as the explanation of the compatibilizer in the injection molding method of the present disclosure, including definitions, examples, preferred embodiments, etc.

### (Ratio)

The explanation of the ratio in the resin composition for molding of the present disclosure is the same as the explanation of the ratio in the injection molding method of the present disclosure, including definitions, examples, preferred embodiments, etc.

### (Other Components)

The explanation of other components in the resin composition for molding of the present disclosure is the same as the explanation of other components in the injection molding method of the present disclosure, including definitions, examples, preferred embodiments, etc.

### <Method for Preparing Resin Composition for Molding>

In the resin composition for molding of the present disclosure, the method for preparing the resin composition for molding is not particularly limited, and can be prepared by a known method. For example, the resin composition for molding can be prepared by mixing raw materials in advance using a mixing device such as a mixer-type mixer, a V-type blender, or a tumbler-type mixer, and melt-kneading the mixture. The melt-kneading device is also not particularly limited, and examples thereof includes a Banbury mixer, a kneader, a roll, a single-screw extruder, a special single-screw extruder, and a twin-screw extruder.

Note that the resin composition for molding of the present disclosure may be molded into a known form by a known method. For example, the resin composition for molding of the present disclosure may be molded into pellets with a pelletizer, or into flakes with a known device, or into pulverized products thereof.

When the resin composition for molding of the present disclosure or a cured product of the resin composition for molding molded into pellets is injection molded, a molded body having a core-shell structure can be produced due to the difference in viscosity between the resin A and the resin B.

### <<Molded Body>>

The molded body of the present disclosure includes a core portion that includes a cured product of a resin A, a shell portion that includes a cured product of a resin B and that covers at least a part of the core portion, and an intermediate portion that is located between the core portion and the shell portion and that includes a cured product of at least one compatibilizer, in which concentrations of the resin A and the resin B each have a distribution that continuously changes from the core portion toward the shell portion.

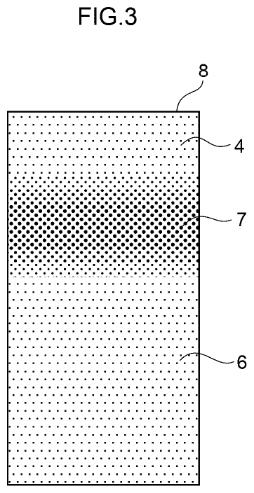

FIG. 3 is an enlarged view of the dotted rectangular frame shown in the cross-sectional view of FIG. 2. As shown in FIG. 3, in the molded body of the present disclosure, the shell portion 4, the intermediate portion 7, and the core portion 6 change in a gradation-like manner from the surface 8 side of the molded body toward the inner side of the molded body.

In the molded body of the present disclosure, the core portion including the cured product of the resin A may include the cured product of the resin B, that is, the resin B may be finely dispersed in the core portion. Furthermore, in the molded body of the present disclosure, the shell portion including the cured product of the resin B may include the cured product of the resin A, that is, the resin A may be finely dispersed in the shell portion. That is, the molded body of the present disclosure may change in a gradation-like manner from the shell portion to the intermediate portion to the core portion.

In the molded body of the present disclosure, the compatibilizer preferably includes at least two compatibilizers.

In the molded body of the present disclosure, the thickness of the shell portion is preferably 300 μm or less, more preferably 200 μm or less, and even more preferably 100 μm or less. Conventionally, for example, when a molded body having a core portion and a shell portion is produced by two-color molding, the thickness of the shell portion becomes 1 mm or more, so the molded body of the present disclosure is a molded body having a very thin shell portion compared to a conventional molded body having a core portion and a shell portion.

In the molded body of the present disclosure, the shell portion only needs to cover at least a part of the core portion, and may cover all of the core portion.

The cross-sectional structure of the molded body of the present disclosure can be identified, for example, by cutting out a thin piece from the molded body of the present disclosure using a microtome and observing the thin piece using a microscope.

In the molded body of the present disclosure, the concentrations of the resin A and the resin B each have a distribution that continuously changes from the core portion toward the shell portion. More specifically, in the molded body, the concentration of the resin A has a distribution that continuously decreases from the core portion toward the shell portion, and the concentration of the resin B has a distribution that continuously increases from the core portion toward the shell portion.

The concentrations of the resins in the molded body of the present disclosure can be determined, for example, by cutting out a thin piece from the molded body of the present disclosure using a microtome and analyzing the thin piece using an infrared spectroscopy (IR). Alternatively, the concentrations of the resin A and the resin B each having a distribution that continuously changes from the core portion toward the shell portion can be confirmed, for example, by cutting out a thin piece from the molded body of the present disclosure and analyzing the thin piece using a transmission electron microscope (TEM).

### EXAMPLES

Hereinafter, the present disclosure will be more specifically explained with reference to Examples, but the present disclosure is not limited to the following Examples unless it goes beyond the gist thereof. Note that unless otherwise specified, “parts” are on the basis of mass. “%” is also on the basis of mass.

### Example 1 to Example 3 and Comparative Example 1 to Comparative Example 5>

### (Preparation of Test Sample)

As Example 1 to Example 3 and Comparative Example 1 to Comparative Example 5, resin compositions for injection molding were each prepared at the blending ratio of the components shown in Table 1 below. For detail, each component was kneaded to prepare a resin composition for injection molding using a kneading extruder under the conditions of a nozzle temperature of from 230° C. to 245° C., an intermediate temperature (temperature of kneading part) of from 230° C. to 245° C., a hopper temperature of from 160° C. to 180° C., a screw rotation speed of 60 rpm, and a feed speed of from 3.0 g/min to 4.0 g/min. Further, the resin composition for injection molding was dried at 80° C. for 12 hours to produce pellets of the resin composition for injection molding.

TABLE 1

| | | | Difference | | | |
|---|---|---|---|---|---|---|
| | | | in apparent | | | Parts by mass of resin |
| | | | viscosity | | | A/resin B/compatibilizer |
| | Resin A | Resin B | (Pa · s) | η_{B}/η_{A} | Compatibilizer | (a)/compatibilizer (b) |
| Comparative | ABS (a) | PP (a) | 0 | 1.00 | — | 90/10/0/0 |
| Example 1 | | | | | | |
| Comparative | ABS (a) | PP (a) | 0 | 1.00 | Compatibilizer (a) and | 90/10/2.5/2.5 |
| Example 2 | | | | | compatibilizer (b) | |
| Comparative | ABS (a) | PP (b) | 1660 | 0.34 | — | 90/10/0/0 |
| Example 3 | | | | | | |
| Example 1 | ABS (a) | PP (b) | 1660 | 0.34 | Compatibilizer (a) and | 90/10/2.5/2.5 |
| | | | | | compatibilizer (b) | |
| Comparative | ABS (b) | PP (a) | 8230 | 0.23 | — | 90/10/0/0 |
| Example 4 | | | | | | |
| Example 2 | ABS (b) | PP (a) | 8230 | 0.23 | Compatibilizer (a) and | 90/10/2.5/2.5 |
| | | | | | compatibilizer (b) | |
| Comparative | ABS (b) | PP (b) | 9890 | 0.08 | — | 90/10/0/0 |
| Example 5 | | | | | | |
| Example 3 | ABS (b) | PP (b) | 9890 | 0.08 | Compatibilizer (a) and | 90/10/2.5/2.5 |
| | | | | | compatibilizer (b) | |

The details of the compounds and abbreviations listed in Table 1 are shown below.
ABS (a): Resin A of the present disclosure
   Acrylonitrile-butadiene-styrene copolymer
   Apparent viscosity 2500 Pa·s
   MFR (230° C., 21.18 N load) 3 g/10 min
   Tensile strength 51 MPa
   Load deflection temperature (1.8 MPa) 95° C.
ABS (b): Resin A of the present disclosure
   Acrylonitrile-butadiene-styrene copolymer
   Apparent viscosity 10730 Pa·s
   MFR (230° C., 21.18 N load) 0.7 g/10 min
   Tensile strength 50 MPa
   Load deflection temperature (1.8 MPa) 101′C
PP(a): Resin B of the present disclosure
Polypropylene resin
Apparent viscosity 2500 Pa·s
MFR (230° C., 21.18 N load) 3 g/10 min
Tensile strength 37 MPa
Homopolymer
PP(b): Resin B of the present disclosure
   Polypropylene resin
   Apparent viscosity 840 Pa·s
   MFR (230° C., 21.18 N load) 9 g/10 min
   Tensile strength 29 MPa
   Copolymer
Compatibilizer (a): First compatibilizer of the present disclosure
   Hydrogenated styrene thermoplastic elastomer (SEBS)
   Mass ratio of styrene/ethylene butylene 67/33
Compatibilizer (b): Second compatibilizer of the present disclosure
   Hydrogenated styrene thermoplastic elastomer (SEBS)
   Mass ratio of styrene/ethylene butylene 20/80
Difference in apparent viscosity; difference in apparent viscosity between resin A and resin B at 230° C.
η_{B}/η_{A}: Ratio of apparent viscosity (η_{B}) of resin B at 230° C. to apparent viscosity (η_{A}) of resin A at 230° C.
-: Corresponding substance was not blended in resin composition for injection molding.

The pellet-shaped resin composition for injection molding was injection molded under the conditions of a molding temperature of 250° C., a nozzle temperature of 250° C., a mold temperature of 70° C., a weighing value of 13.5 mm, a weighing speed of 2 mm, an injection speed (I.S) of 30 mm/s, an injection speed (V-P) of 5.2 mm, a filling and holding pressure of 90%, a filling and holding pressure time of 15 seconds, a cooling time of 15 seconds, and an injection peak pressure of from 111% to 118%.

By the injection molding, strip-shaped test samples having a length of 50 mm, a width of 5 mm, and a thickness of 2 mm were each produced.

### (Chloroform Immersion)

A test piece with a length of 15 mm, a width of 5 mm, and a thickness of 2 mm was cut out from each strip-shaped test sample. Each test piece was immersed in a chloroform solution of 99% by mass or higher at 25±5° C. for 120 hours. When the test samples of Comparative Example 1 and Comparative Example 2 were immersed in chloroform, ABS was dissolved and the chloroform solution changed from transparent to black. On the other hand, in Comparative Example 5 and Example 3, ABS was not dissolved, and the chloroform solution remained transparent. This is because ABS is easily dissolved in chloroform and PP is difficult to be dissolved in chloroform. That is, when the resin A and the resin B have different apparent viscosities at 230° C. as in Comparative Example 5 and Example 3, a molded body having a core-shell structure in which PP is mainly present in the shell portion and ABS is mainly present in the core portion was obtained.

### (Acetone Steam Etching of Cross Section)

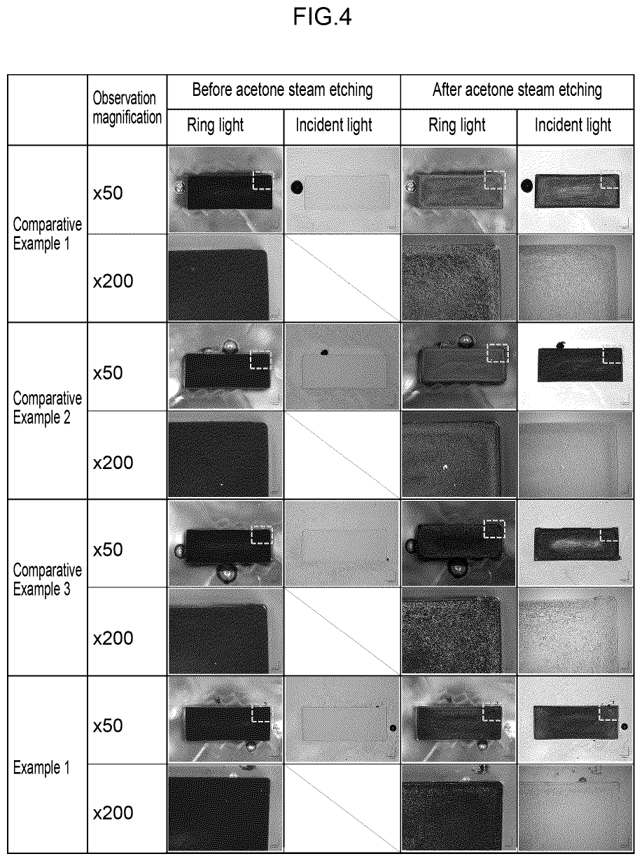

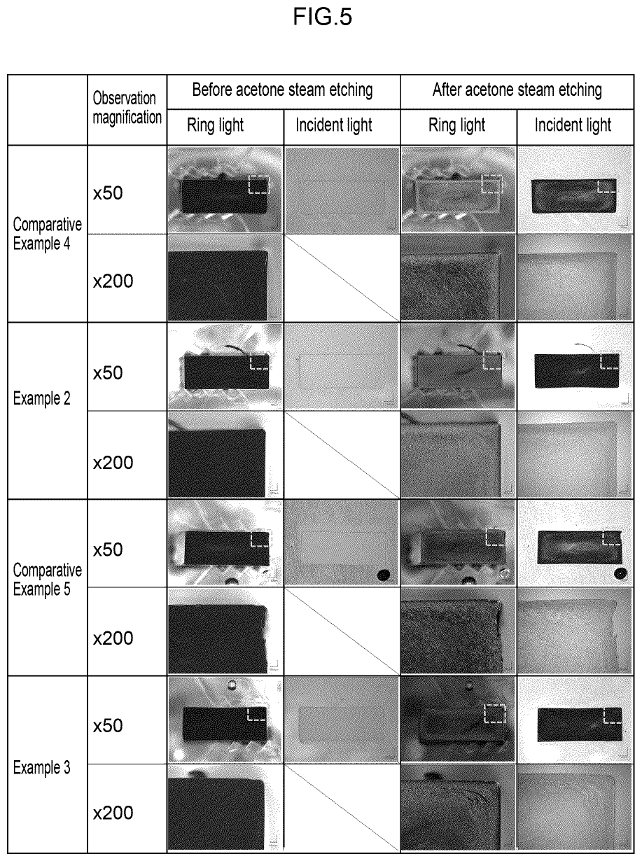

After embedding in epoxy resin and polishing the cross section, the cross section of each strip-shaped test sample at approximately the center in the length direction was observed using a ring light or an incident light at an observation magnification of 50× or 200×. After observation, the test sample was placed on the top of a container containing acetone so that the cross section of the test sample faced acetone. After etching the test sample for 60 seconds at 25±5° C. with acetone vapor, taking care not to touch the test sample directly, the cross section was observed again using a ring light or an incident light at an observation magnification of 50× or 200×. Note that a microscope was used to observe the cross section. The results of cross-sectional observation are shown in FIGS. 4 and 5. Note that in FIGS. 4 and 5, the observation results obtained using an observation magnification of 200× are the enlarged portions within the dotted line rectangular frame at the upper right of each cross section in the observation results obtained using an observation magnification of 50×.

When observing the cross section of the test sample before acetone vapor etching, in Example 1 to Example 3 and Comparative Example 3 to Comparative Example 5, a shell portion (part mainly containing PP) with a thickness of 100 μm was confirmed at the surface side of the test sample (i.e., the outside of the cross section of the test sample).

When observing the cross section of the test sample after acetone vapor etching, in Comparative Example 1, Comparative Example 3, Comparative Example 4, and Comparative Example 5, in which no compatibilizer was blended, the difference in color density between the shell portion and the core portion was confirmed, and the boundary between the shell portion and the core portion was clear. This is because ABS does not have acetone resistance, so the core portion (part mainly containing ABS) was etched by acetone vapor, and the cracks in ABS appeared white, and PP has acetone resistance, so the shell portion (part mainly containing PP) was difficult to be etched by acetone vapor and remained black.

On the other hand, in Comparative Example 2 and Example 1 to Example 3, in which a compatibilizer was blended, the difference in color density between the shell portion and the core portion was unclear, and the boundary between the shell portion and the core portion was unclear. This is because PP was also mixed into the core portion (part mainly containing ABS) due to the compatibilizer, by which the acetone resistance of the core portion was improved.

Furthermore, in Comparative Example 1 and Comparative Example 2 in particular, an incomplete core-shell structure was formed in which the thickness of the shell portion (part mainly containing PP) was too small, whereas in Comparative Example 5 and Example 3 in particular, a core-shell structure with a thick shell portion was formed. In other words, when the apparent viscosities of the resin A and the resin B at 230° C. are different, a molded body having a core-shell structure in which PP is mainly present in the shell portion and ABS is mainly present in the core portion was obtained.

From the above, in Example 1 to Example 3, it was possible to provide an injection molding method that allows a molded body having a structure in which a core portion and a shell portion are formed of different resins to be obtained by one injection molding of a resin composition, a resin composition for molding used in the method, and a molded body obtained by the method.

In Example 1 to Example 3, two compatibilizers (compatibilizer (a) and compatibilizer (b)) are used. Here, the styrene/ethylene-butylene ratio (mass ratio) of the compatibilizer (a) is 67/33, which means that the styrene ratio is high, that is, the ratio of a constitutional unit derived from an aromatic hydrocarbon is high. Therefore, the compatibilizer (a) was easily compatible with ABS having a constitutional unit derived from an aromatic hydrocarbon (styrene). On the other hand, the styrene/ethylene-butylene ratio (mass ratio) of the compatibilizer (b) is 20/80, which means that the ethylene butylene ratio is high, that is, the ratio of a constitutional unit derived from an unsaturated aliphatic hydrocarbon is high. Therefore, the compatibilizer (b) was easily compatible with PP having a constitutional unit derived from an unsaturated aliphatic hydrocarbon (propylene).

That is, the structure of the molded body produced in each of Example 1 to Example 3 had a structure that continuously contains, from the surface side of the molded body toward the inner side of the molded body, a part mainly containing PP, a part mainly containing PP and the compatibilizer (b), a part mainly containing the compatibilizer (b) and the compatibilizer (a), a part mainly containing the compatibilizer (a) and ABS, and a part mainly containing ABS.

### (Transmission Electron Microscope (TEM) Analysis of Molded Body)

A thin piece was cut out from a test piece having a length of 10 mm, a width of 5 mm, and a thickness of 2 mm prepared under the conditions of Example 3 described above. Using a transmission electron microscope (TEM), the dispersion distribution of the resin A and the resin B in the test piece from the core portion toward the shell portion was observed. Note that the observation was performed at four points in total (the outermost surface side of the test piece, and the depths of about 50 μm, about 100 μm, and about 150 μm from the outermost surface side).

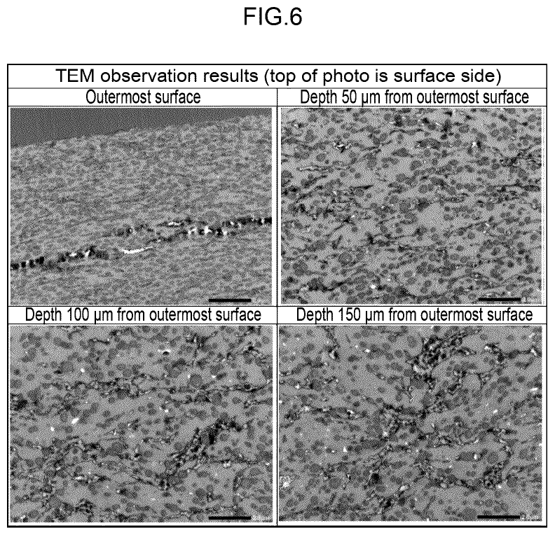

The observation results are shown in FIG. 6. Note that the length of each scale bar shown at the bottom right of the figure is 2.0 μm.

The phase that is assumed to be an aliphatic hydrocarbon material is amorphous, and it was observed that the size of the phase tended to increase as it went deeper from the outermost surface. On the other hand, it was observed that the total amount of aliphatic hydrocarbon materials in the entire observation field of view tended to increase from the inner side toward the outermost surface. A layer-separated structure (i.e., core-shell structure) was observed within the phase, and two phases of an amorphous island phase with a lamellar structure and a circular island phase were observed to be dispersed. Further, between the inner side and the outermost surface side, a part that is assumed to include a larger amount of the compatibilizer than the inner side and the outermost surface side was observed.

That is, in the test sample (i.e., the molded body of the present disclosure), the resin A and the resin B each had a distribution that continuously changed from the core portion (inside) toward the shell portion (outermost surface side). Furthermore, it was confirmed that the test sample had an intermediate portion that was located between the core portion and the shell portion and that included a relatively large amount of the compatibilizer, and was a molded body as shown in FIG. 3. Therefore, it was confirmed that the resin A was compatible with the first compatibilizer, and the resin B was compatible with the second compatibilizer.

### Example 3 to Example 5 and Comparative Example 6 to Comparative Example 7

### (Preparation of Test Sample)

In addition to the aforementioned Example 3, as Example 4 and Example 5, resin compositions for injection molding were respectively prepared at the blending ratio of the components shown in Table 2 below and pellets of the resin compositions for injection molding were then produced in the same as in the methods in Example 1 to Example 3 and Comparative Example 1 to Comparative Example 5. As Comparative Example 6 and Comparative Example 7, resin compositions for injection molding were prepared using the components shown in Table 2 below. The details of the compounds and abbreviations listed in Table 2 are the same as those in Table 1.

For Example 3 to Example 5, the pellet-shaped resin compositions for injection molding were injection molded under the respective conditions shown in Table 2 below. For Comparative Example 6 and Comparative Example 7, the resin compositions for injection molding were injection molded under the respective conditions shown in Table 2 below. Through the operations above, ISO multipurpose test pieces (test sample 1 to test sample 6) were each prepared.

TABLE 2

| | Resin | | | Difference | | | |
|---|---|---|---|---|---|---|---|
| | composition | | | in apparent | | | Parts by mass of resin |
| | for injection | | | viscosity | | | A/resin B/compatibilizer |
| | molding used | Resin A | Resin B | (Pa · s) | η_{B}/η_{A} | Compatibilizer | (a)/compatibilizer (b) |
| Test | Example 4 | ABS (a) | PP (b) | 1660 | 0.34 | Compatibilizer (a) and | 97.4/2.6/2.5/2.5 |
| sample 1 | | | | | | compatibilizer (b) | |
| Test | Example 3 | ABS (b) | PP (b) | 9890 | 0.08 | Compatibilizer (a) and | 90/10/2.5/2.5 |
| sample 2 | | | | | | compatibilizer (b) | |
| Test | Example 5 | ABS (b) | PP (b) | 9890 | 0.08 | Compatibilizer (a) and | 97.4/2.6/2.5/2.5 |
| sample 3 | | | | | | compatibilizer (b) | |
| Test | Example 3 | ABS (b) | PP (b) | 9890 | 0.08 | Compatibilizer (a) and | 90/10/2.5/2.5 |
| sample 4 | | | | | | compatibilizer (b) | |
| Test | Comparative | — | PP (b) | | | — | 0/100/0/0 |
| sample 5 | Example 6 | | | | | | |
| Test | Comparative | ABS (b) | — | | | — | 100/0/0/0 |
| sample 6 | Example 7 | | | | | | |

| | | Extrusion molding conditions | | | Injection | |
|---|---|---|---|---|---|---|
| | Resin | | | Screw | molding conditions | |
| | composition | Cylinder | Feed | rotation | Cylinder | Mold |
| | for injection | temperature | speed | speed | temperature | temperature |
| | molding used | (° C.) | (kg/h) | (rpm) | (° C.) | (° C.) |
| Test | Example 4 | 230 | 10 | 60 | 250 | 60 |
| sample 1 | | | | | | |
| Test | Example 3 | 230 | 10 | 60 | 250 | 60 |
| sample 2 | | | | | | |
| Test | Example 5 | 230 | 5 | 100 | 250 | 60 |
| sample 3 | | | | | | |
| Test | Example 3 | 250 | 5 | 100 | 250 | 60 |
| sample 4 | | | | | | |
| Test | Comparative | — | — | — | 250 | 70 |
| sample 5 | Example 6 | | | | | |
| Test | Comparative | — | — | — | 250 | 70 |
| sample 6 | Example 7 | | | | | |

### (Polishing of Test Piece)

Using the test sample 1 to the test sample 6, a “non-polished test piece” and a “polished test piece” were each prepared. Specifically, as the “non-polished test piece”, the end (excluding the gate side) of a Charpy impact test piece taken out from the test sample between the marked lines was used. In addition, in order to prevent adhesion and dissolution of chloroform at the cut surface, the cut surface was sealed using PP(b). On the other hand, as the “polished test piece”, a piece in which the shell portion was removed by polishing one side of the test sample by 1 mm (grain size #120) was used. Note that the cut surface of the polished test piece was not sealed.

### (Chloroform Immersion)

10 ml of a chloroform solution of 99% by mass or higher was put into a screw tube (50 ml volume), and the non-polished test piece or the polished test piece was immersed at 25±5° C. for 24 hours with the cut surface facing upward. The results of observing the condition of each test solution (chloroform solution) and each test piece at regular intervals are shown in Table 3.

TABLE 3

| | | | | | | | | | | | Test | | |
|---|---|---|---|---|---|---|---|---|---|---|---|---|---|
| | | | Test sample 1 | | Test sample 2 | | Test sample 3 | | Test sample 4 | | sample 5 | Test sample 6 | |
| | | | Non- | | Non- | | Non- | | Non- | | Non- | Non- | |
| | | | polished | Polished | polished | Polished | polished | Polished | polished | Polished | processed | polished | Polished |
| Immersion | 1 | hour | 4 | 3 | 5 | 4 | 5 | 4 | S | 4 | 5 | 3 | 3 |
| time | 2 | hours | 3 | 2 | 5 | 3 | 5 | 4 | 5 | 3 | 5 | 3 | 3 |
| | 3 | hours | 3 | 2 | 5 | 3 | 4 | 3 | 5 | 3 | 5 | 3 | 2 |
| | 5 | hours | 2 | 0 | 5 | 3 | 4 | 0 | 5 | 3 | 5 | 3 | 0 |
| | 7 | hours | 0 | 0 | 5 | 3 | 0 | 0 | 5 | 3 | 5 | 0 | 0 |
| | 24 | hours | 0 | 0 | 5 | 3 | 0 | 0 | 5 | 3 | 5 | 0 | 0 |

| | | | | | | | | | | | |
|---|---|---|---|---|---|---|---|---|---|---|---|
| Total score | 12 | 7 | 30 | 19 | 18 | 11 | 30 | 19 | 30 | 12 | 8 |

| | | | | | | |
|---|---|---|---|---|---|---|
| Difference | 5 | 11 | 7 | 11 | — | 4 |

In Table 3, the condition of each test solution (chloroform solution) and each test piece was evaluated in 5 stages (5, 4, 3, 2, or 0 points) based on the following criteria.

5 points: The test solution had high transparency and no black turbidity was observed.

4 points: The test solution had high transparency, but slight black turbidity occurred.

3 points: The test solution had low transparency, and black turbidity occurred throughout. The shape of the test piece was maintained.

2 points: The test solution had a deep black turbidity, and dissolution was observed to the extent that the shape of the test piece partially collapsed (swelling not included).

0 points: The test solution had a deep black turbidity, and the shape of the test piece was not maintained (swelling not included).

In Table 3, “difference” indicates a difference between the total score for the non-polished test piece and the total score for the polished test piece. “-” indicates that the difference was not calculated.

In this chloroform immersion test, it is possible to confirm the presence or absence of a core-shell structure in the molded body by checking the presence or absence of chloroform resistance. For example, in this example, w % ben a molded body has a layer-separated structure (i.e., core-shell structure), a core portion is present at an outermost surface (i.e., outermost surface is mainly made of PP, which is difficult to dissolve in chloroform), so the molded body has chloroform resistance. However, when the surface of the molded body having a layer-separated structure is polished to remove the outermost surface (i.e., PP), ABS, which is easily soluble in chloroform, is exposed, so the chloroform resistance of the molded body is decreased. Therefore, those with a large difference between before polishing (i.e., “non-polished test piece”) and after polishing (i.e., “polished test piece”) were judged to have a layer-separated structure. According to the test sample 6 (molded body made of ABS alone), there was a difference of 4 points between the non-polished test piece and the polished test piece, so this was considered as the score for changes in chloroform resistance due to changes in plate thickness and volume. If the difference in the molded body was greater than 4 points, it was determined that the molded body has a layer-separated structure (i.e., core-shell structure).

That is, in the test sample 1 to the test sample 4, molded bodies having more favorable core-shell structures were obtained.

The disclosure of Japanese Patent Application No. 2021-172695, filed Oct. 21, 2021, is incorporated herein by reference in its entirety.

All publications, patent applications, and technical standards mentioned in the present specification are herein incorporated by reference to the same extent as if each individual publication, patent application, or technical standard was specifically and individually indicated to be incorporated by reference.

1. An injection molding method, comprising injecting a resin composition for molding as a raw material, the resin composition comprising at least two resins having different apparent viscosities at 230° C. and at least one compatibilizer.

2. The injection molding method according to claim 1, wherein the resins comprise a resin A and a resin B, a difference in apparent viscosity between the two resins with a smallest difference in apparent viscosity at 230° C. among the at least two resins being from 1000 Pa·s to 50000 Pa·s.

3. The injection molding method according to claim 2, wherein a ratio (η_{B}/η_{A}) of an apparent viscosity (η_{B}) of the resin B at 230° C. to an apparent viscosity (η_{A}) of the resin A at 230° C. is from 0.01 to 0.4.

4. The injection molding method according to claim 2, wherein the compatibilizer comprises a first compatibilizer that is compatible with the resin A and a second compatibilizer that is compatible with the resin B.

5. The injection molding method according to claim 4, wherein the resin A is from 40% by mass to 99% by mass, the resin B is from 0.1% by mass to 40% by mass, the first compatibilizer is from 0.1% by mass to 20% by mass, and the second compatibilizer is from 0.1% by mass to 20% by mass, each with respect to a total mass of the resin composition for molding.

6. The injection molding method according to claim 4, wherein the first compatibilizer and the second compatibilizer are both organic compounds.

7. The injection molding method according to claim 4, wherein the resin A is a resin containing a constitutional unit derived from an aromatic hydrocarbon, and the resin B is a resin containing a constitutional unit derived from an unsaturated aliphatic hydrocarbon.

8. The injection molding method according to claim 7, wherein:
the first compatibilizer and the second compatibilizer are copolymers;
a content of the constitutional unit derived from an aromatic hydrocarbon in the first compatibilizer exceeds 50% by mass with respect to all constitutional units of the first compatibilizer; and
a content of the constitutional unit derived from an unsaturated aliphatic hydrocarbon in the second compatibilizer exceeds 50% by mass with respect to all constitutional units of the second compatibilizer.

9. A resin composition for molding, comprising at least two resins and at least one compatibilizer, wherein the resins comprise a resin A and a resin B, a difference in apparent viscosity between the two resins with a smallest difference in apparent viscosity at 230° C. among the at least two resins being from 1000 Pa·s to 50000 Pa·s.

10. The resin composition for molding according to claim 9, wherein a ratio (η_{B}/η_{A}) of an apparent viscosity (η_{B}) of the resin B at 230° C. to an apparent viscosity (η_{A}) of the resin A at 230° C. is from 0.01 to 0.4.

11. The resin composition for molding according to claim 9, wherein the compatibilizer comprises a first compatibilizer that is compatible with the resin A and a second compatibilizer that is compatible with the resin B.

12. The resin composition for molding according to claim 11, wherein the first compatibilizer and the second compatibilizer are both organic compounds.

13. The resin composition for molding according to claim 11, wherein the resin A is a resin containing a constitutional unit derived from an aromatic hydrocarbon, and the resin B is a resin containing a constitutional unit derived from an unsaturated aliphatic hydrocarbon.

14. The resin composition for molding according to claim 13, wherein:
the first compatibilizer and the second compatibilizer are copolymers;
a content of the constitutional unit derived from an aromatic hydrocarbon in the first compatibilizer exceeds 50% by mass with respect to all constitutional units of the first compatibilizer; and
a content of the constitutional unit derived from an unsaturated aliphatic hydrocarbon in the second compatibilizer exceeds 50% by mass with respect to all constitutional units of the second compatibilizer.

15. A molded body, comprising:
a core portion that comprises a cured product of a resin A;
a shell portion that comprises a cured product of a resin B and that covers at least a part of the core portion; and
an intermediate portion that is located between the core portion and the shell portion and that comprises a cured product of at least one compatibilizer,
wherein concentrations of the resin A and the resin B each have a distribution that continuously changes from the core portion toward the shell portion.

16. The molded body according to claim 15, wherein the compatibilizer comprises at least two compatibilizers.

17. The molded body according to claim 15, wherein the shell portion has a thickness of 300 μm or less.
